(19) United States
(12) Patent Application Publication
(10) Pub. No.: US 2006/0151945 A1
(43) Pub. Date: Jul. 13, 2006

(54) Nozzle for a random selection machine

(76) Inventors: Yueh-Chun Lin, Taichung (TW); Hsi-Wang Hsieh, Taichung (TW)

Correspondence Address: Rabin & Berdo, P.C., Suite 500, 1101 14th Street, Washington, DC, 20005, US

(21) Appl. No.: 11/030,179

(22) Filed: Jan. 7, 2005

(51) Int. Cl. G07C 15/00; A63F 9/04

(52) U.S. Cl. 273/144 R; 273/145 C; 273/144 A

(57) ABSTRACT

A nozzle has a body provided with multiple laminar flow passages to generate multiple laminar flows when air is exhausted from the nozzle into a barrel of a random selection machine. When air is blown into a barrel through the nozzle, the airflow exhausting out from the blower will be compressed by the laminar flow passages in the nozzle. The airflow will be divided into multiple jetting laminar flows due to the passages even when turbulent flow has generated. Accordingly, the speed of the air entering into the barrel of the selection machine through the nozzle is high such that numbered balls can be gathered evenly.

### BACKGROUND OF THE INVENTION

1. Field of the Invention

The present invention relates to a nozzle, and more particularly to a nozzle for a random selection machine.

2. Description of Related Art

Bingo and lotteries are commonly conducted with a random selection machine that can automatically select numbered balls. With reference to FIG. 7, a conventional selection machine substantially comprises a base (60), a barrel (62), a blower (64), a ball selector (66) and two helical tubes (68). The blower (64) is mounted in the base (60) and is connected to the barrel (62) to blow air into the barrel (62). With the air blown into the barrel (62), numbered balls will randomly jump inside the barrel (62) and will be gathered individually by the ball selector (66) so that bingo, lottery etc can be played.

With further reference to FIG. 8, a nozzle (70) is mounted between the blower (64) and the barrel (62) to spray air into the barrel (62). The conventional nozzle (70) is a tubular element with a single flow passage (72) defined through the nozzle (70) and communicating with a flow channel in the blower (64). Accordingly, the air can be blown into the barrel (62) through the flow passage (72) in the nozzle (70). In addition a mesh (74) is mounted in the flow passage (72) to keep the numbered balls from entering into the blower (64) through the passage (72).

However, when the air enters the barrel (62) through the flowpassage (72) in the nozzle (70), turbulent flow will easily and quickly occur in the barrel (62) at a location near the nozzle (70) because the inner diameter in the barrel (62) is much larger than that of the flow passage (72). Consequently, the speed of the air in the barrel (62) is slow, such that the jumping speed of the numbered balls in the barrel (62) is also slow. Therefore, the balls cannot be stirred evenly in the barrel (62) with the slow airflow, and the balls cannot be evenly gathered.

To overcome the shortcomings, the present invention tends to provide a nozzle to mitigate or obviate the aforementioned problems.

### SUMMARY OF THE INVENTION

The main objective of the invention is to provide a nozzle for a random selection machine and that can increase the speed of the air in the barrel of the selection machine to make the balls be gathered evenly. The nozzle has a body provided with multiple laminar flow passages to generate multiple laminar flows when air is exhausted from the nozzle into a barrel of the selection machine.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a nozzle for a random selection machine for gambling in accordance with the present invention;

FIG. 2 is a partial side plan view in partial cross section of a barrel of the selection machine with a nozzle in FIG. 1;

FIG. 3 is a perspective view of a second embodiment of a nozzle for a random selection machine in accordance with the present invention;

FIG. 4 is a partial side plan view in partial cross section of a barrel of the selection machine with a nozzle in FIG. 3;

FIG. 5 is a perspective view of a third embodiment of a nozzle for a random selection machine in accordance with the present invention;

FIG. 6 is a partial side plan view in partial cross section of a barrel of the random selection machine with a nozzle in FIG. 6;

FIG. 7 is a side plan view of a conventional random selection machine for gambling in accordance with the prior art; and

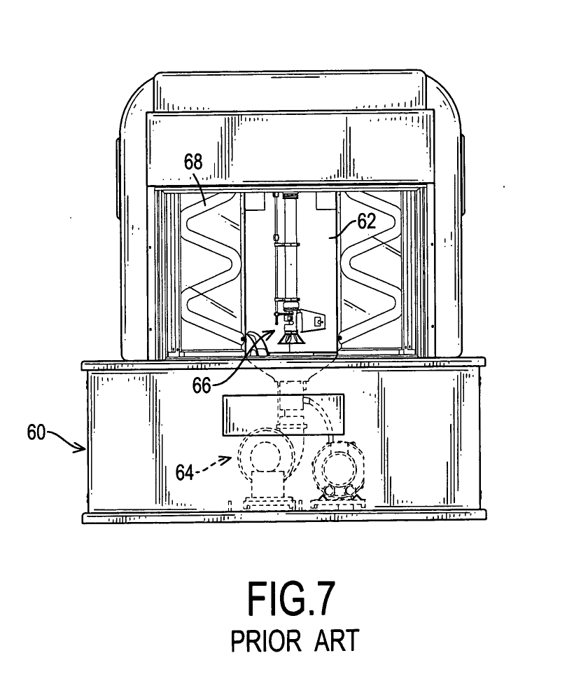

FIG. 8 is a perspective view of a bottom of a barrel of the conventional selection machine with a conventional nozzle in accordance with the prior art.

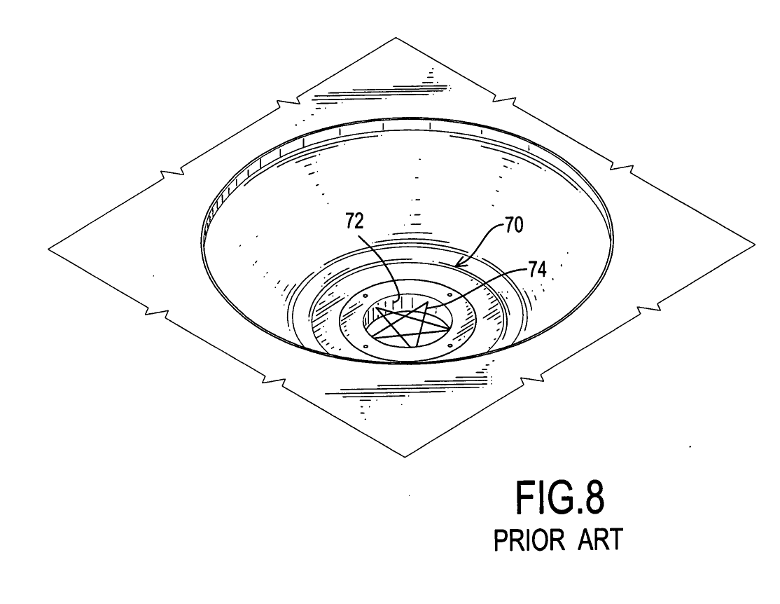

### DETAILED DESCRIPTION OF PREFERRED EMBODIMENT

A nozzle for a random selection machine for gambling in accordance with the present invention comprises a body provided with multiple laminar flow passages to generate multiple laminar flows when air is exhausted from the nozzle into a barrel of the selection machine.

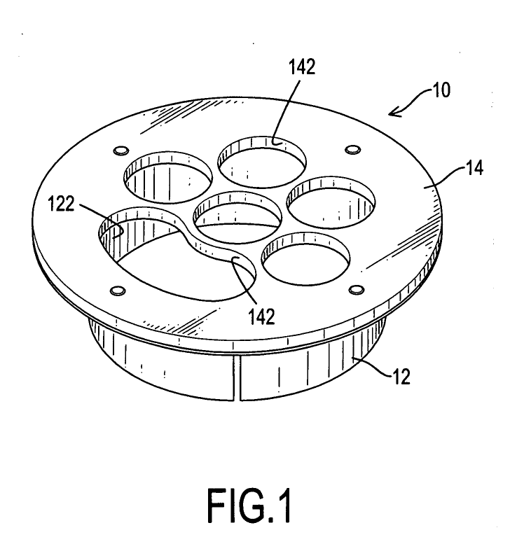

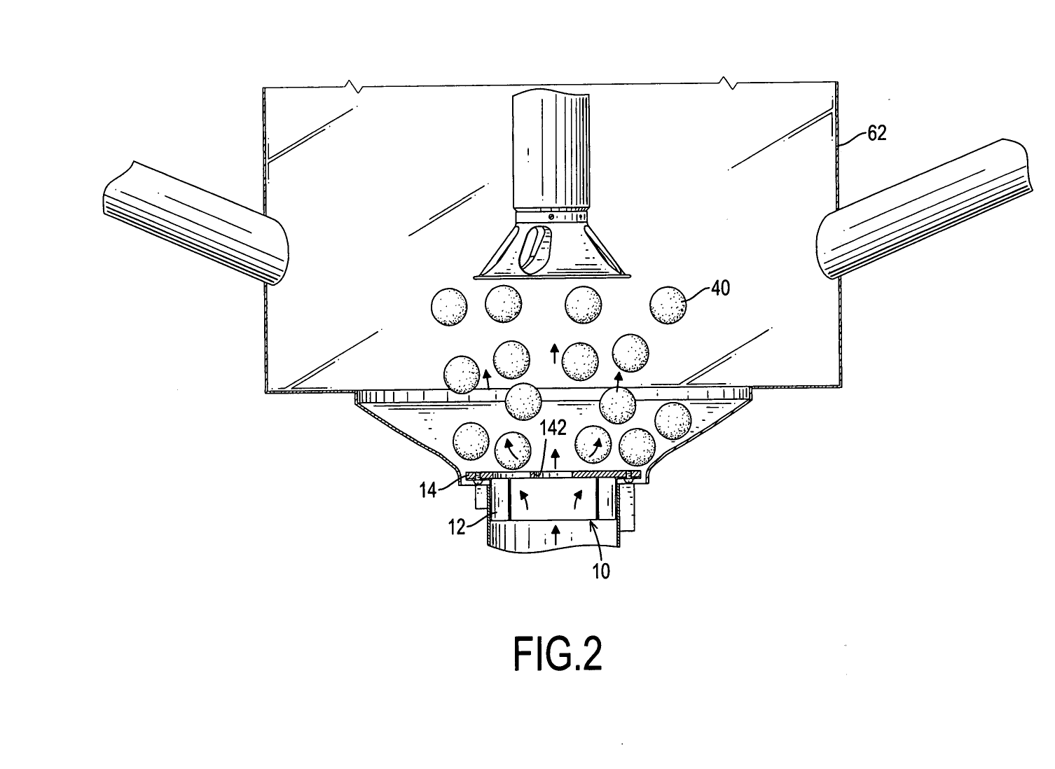

With reference to FIGS. 1 and 2, a first embodiment of a body (10) of a nozzle in accordance with the present invention comprises a connecting tube (12) and a top flange (14). The connecting tube (12) has a top and a central passage (122) defined through the connecting tube (12). The top flange (14) is attached to the top of the tube (12) to close the central passage (122) and has multiple bores (142) defined through the flange (14) and communicating with the central passage (122) in the connecting tube (12). With the bores (142) in the top flange (14), multiple laminar flow passages are defined.

In such an arrangement, when air is blown into a barrel (62) through the nozzle, the airflow exhausting out from the blower will be compressed by the bores (142) in the nozzle. The airflow will be divided into multiple jetting laminar flows due to the bores (142) in the top flange (14) even when turbulent flow has generated. Consequently, turbulent flow will not easily occur at a location near the nozzle, and the speed of the airflow in the barrel (62) is increased. Accordingly, the movement of numbered balls (40) is faster than that of the balls in a barrel with a conventional nozzle, such that the numbered balls can be stirred evenly.

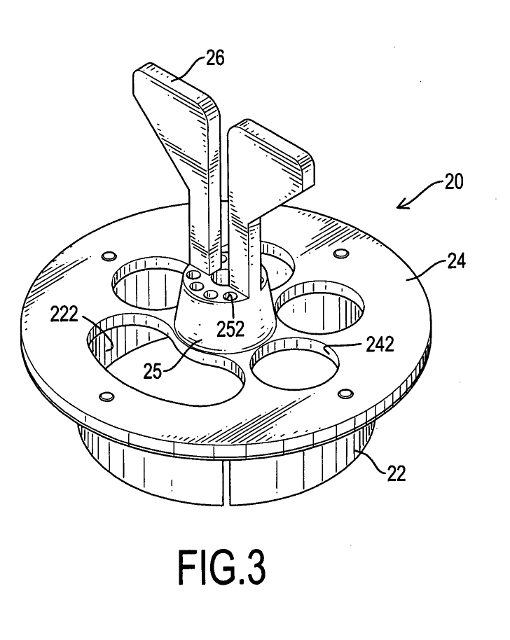

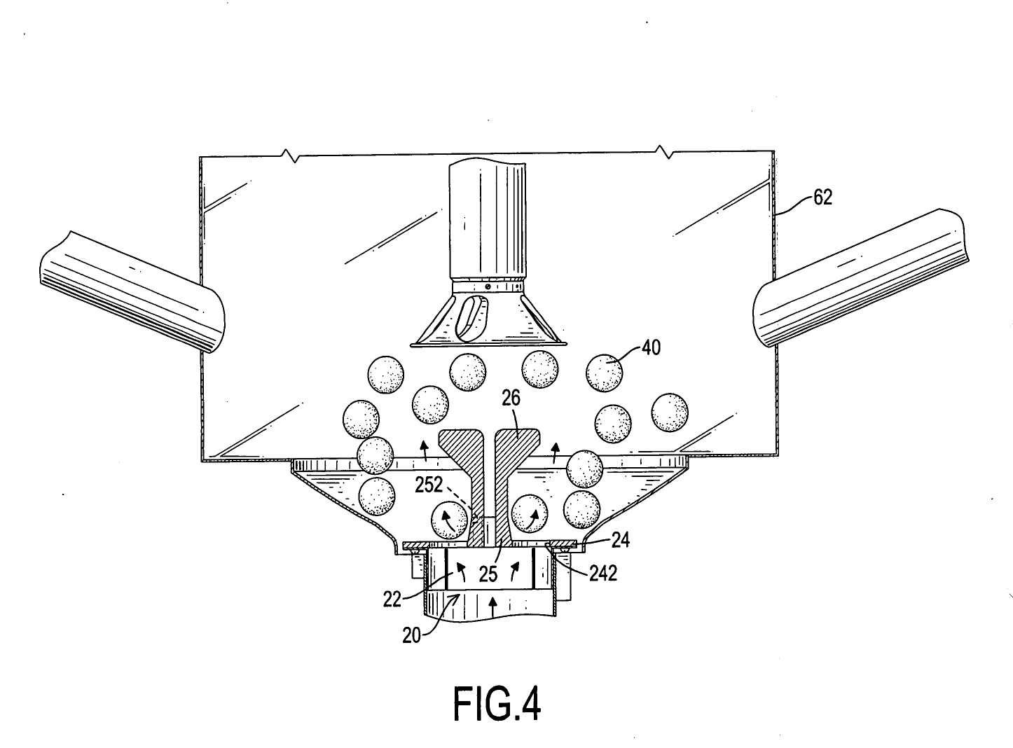

With reference to FIGS. 3 and 4, a second embodiment of a body (20) of a nozzle in accordance with the present invention comprises a connecting tube (22), a top flange (24) and a guiding plate (26). The connecting tube (22) has a top and a central passage (222) defined through the tube (22). The top flange (24) is attached to the top of the tube (22) to close the central passage (222) and has a center and multiple bores (242) defined through the flange (24) and communicating with the central passage (222) in the connecting tube (22). With the bores (242) in the top flange (24), multiple laminar flow passages are defined. The guiding plate (26) extends upward from the center of the top flange (24). In a preferred embodiment, a protrusion (25) is formed on the center of the top flange (24), and the guiding plate (26) is formed on and extends upward from the protrusion (25). The protrusion (25) further has multiple through holes (252) defined through the protrusion (25) and communicating with the central passage (222) in the connecting tube (22). The through holes (252) are also formed as multiple laminar flow passages. The through holes (252) has a diameter smaller than that of the bores (242) in the flange (24), such that the airflow exhausting from the through holes (252) has a pressure larger than that of the airflow exhausting from the bores (242).

With the arrangement of the guiding plate (26), the laminar flows exhausting from the bores (242) in the top flange (24) and the through holes (252) in the protrusion (25) will not easily disperse due to the guiding effect provided by the guiding plate (26). Consequently, turbulent flow does not easily occur, and the speed of the airflow will keep at a high level even at a location far away from the nozzle.

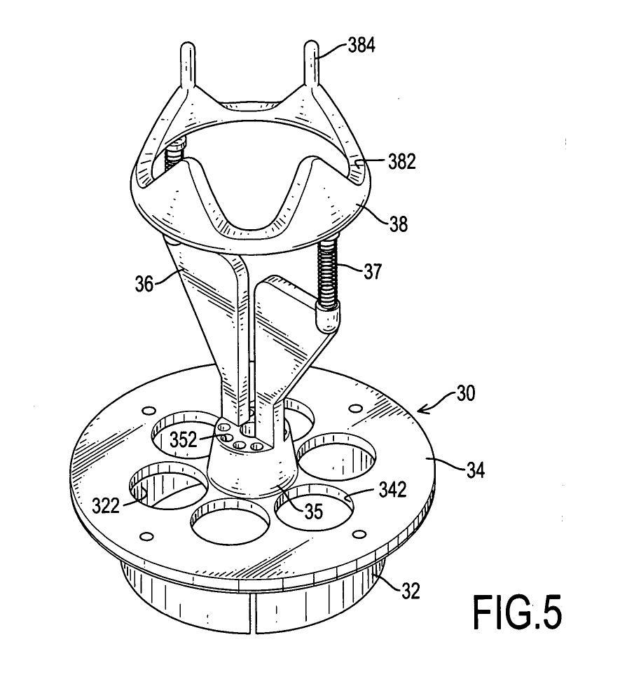

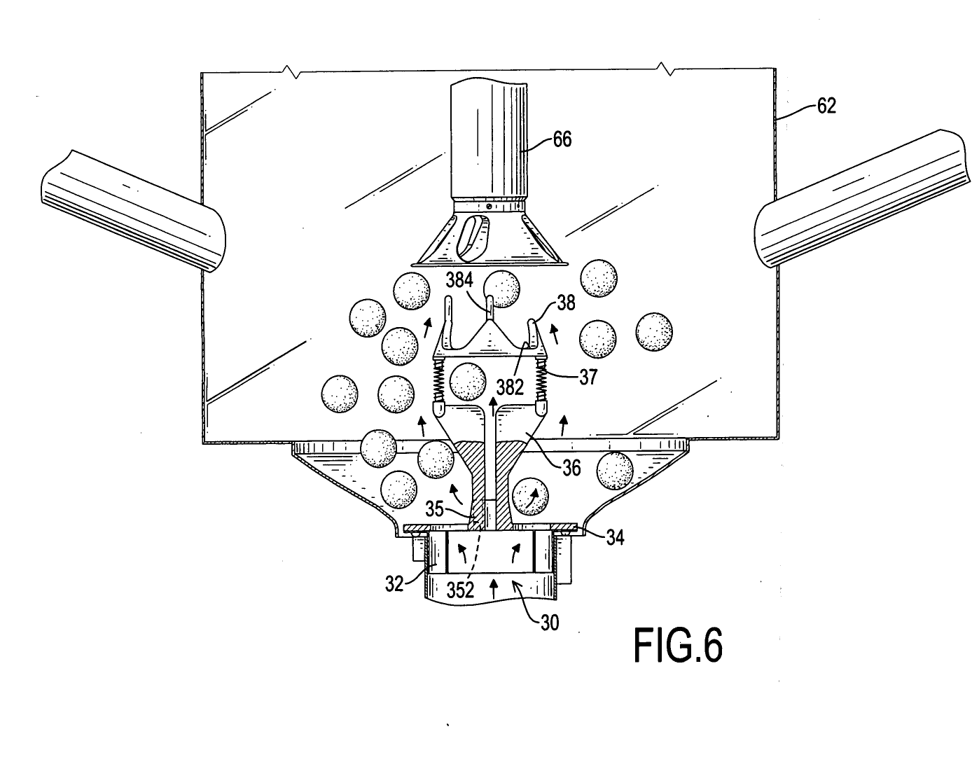

With reference to FIGS. 5 and 6, a third embodiment of a body (30) of a nozzle in accordance with the present invention comprises a connecting tube (32), a top flange (34), a guiding plate (36) and guiding collar (38). The connecting tube (32) has a top and a central passage (322) defined through the tube (32). The top flange (34) is attached to the top of the tube (32) to close the central passage (322) and has a center and multiple bores (342) defined through the flange (34) and communicating with the central passage (322) in the connecting tube (32). With the bores (342) in the top flange (34), multiple laminar flow passages are defined. The guiding plate (36) extends upward from the center of the top flange (34). In a preferred embodiment, a protrusion (35) is formed on the center of the top flange (34), and the guiding plate (36) is formed on and extends upward from the protrusion (35). The protrusion (35) further has a top and multiple through holes (352) defined through the protrusion (35) and communicating with the central passage (322) in the connecting tube (32). The through holes (352) are also formed as multiple laminar flow passages. The guiding collar (38) is connected to the top of the guiding plate (36) to provide a further guiding effect to the jetting laminar flows. In a preferred embodiment, two resilient members (37) are attached to the top of the guiding plate (36), and the guiding collar (38) is supported on the resilient members (37) such that the guiding collar (38) can be vibrated relative to the guiding plate (36).

With the arrangement of the guiding collar (38), a guiding effect to the jetting laminar flows is further provided, and the laminar flows will not easily disperse with the guiding effect provided by the guiding collar (38). Consequently, the speed of the laminar flows will keep at a high level during the travel between the nozzle and the ball selector (66), such that the numbered balls (40) will randomly jump inside the barrel (62) at a high speed and will be stirred in a particular even manner.

In addition, the guiding collar (38) has a top and multiple concave notches (382) defined in the top to allow the numbered balls (40) to exit the collar (38) through the notches (382). Furthermore, two guiding rods (384) extend from the top of the guiding collar (38). With the arrangement of the guiding rods (384), the guiding effect provided to the laminar flows by the guiding collar (38) will be prolonged, and the guiding collar (38) can provide different guiding effects to the laminar flows with the guiding rods (384). Accordingly, the flows near the collar (38) are at different speed levels, such that the balls will be stirred particularly evenly.

In an alternative embodiment, the body is composed of multiple tubes each having a central channel to form laminar flow passages in the body.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A nozzle for a random selection machine, comprising a barrel and an air activating device connected to the barrel, the nozzle adapted to mounted between the barrel and the activating device and comprising:
a body provided with multiple laminar flow passages to generate multiple laminar flows when air is exhausted from the nozzle into the barrel of the random selection machine.

2. The spraying nozzle as claimed in claim 1, wherein the body comprises
a connecting tube having a top and a central passage defined through the connecting tube; and
a top flange attached to the top to close the central passage and having multiple bores defined through the flange and communicating with the central passage in the connecting tube to form the laminar flow passages.

3. The spraying nozzle as claimed in claim 2, wherein the body further has a guiding plate extending upward from a center of the top flange.

4. The spraying nozzle as claimed in claim 3, wherein the body further has a protrusion formed on the center of the top flange; and
the guiding plate is formed on and extends upward from the protrusion.

5. The spraying nozzle as claimed in claim 4, wherein the protrusion further has multiple through holes defined through the protrusion and communicating with the central passage in the connecting tube.

6. The spraying nozzle as claimed in claim 5 further comprising a guiding collar connected to a top of the guiding plate to provide a further guiding effect to the laminar flows.

7. The spraying nozzle as claimed in claim 6 further comprising two resilient members attached to the top of the guiding plate to support the guiding collar.

8. The spraying nozzle as claimed in claim 7, wherein the guiding collar has a top and multiple concave notches defined in the top to allow balls to exit the collar through the notches.

9. The spraying nozzle as claimed in claim 8, wherein the guiding collar further has two guiding rods extending from the top of the guiding collar.

10. The spraying nozzle as claimed in claim 6, wherein the guiding collar has a top and multiple concave notches defined in the top to allow balls to exit the collar through the notches.

11. The spraying nozzle as claimed in claim 10, wherein the guiding collar further has two guiding rods extending from the top of the guiding collar.
